(19) United States
(12) Patent Application Publication
(10) Pub. No.: US 2002/0184771 A1
(43) Pub. Date: Dec. 12, 2002

(54) Wilderness survival methods and apparatuses

(76) Inventor: Edward Kaufer, Reno, NV (US)

Correspondence Address: Herbert C. Schulze, 2790 Wrondel Way, PMB36, Reno, NV, 89502, US

(21) Appl. No.: 09/934,008

(22) Filed: Aug. 20, 2001

Related U.S. Application Data
(62) Division of application No. 09/867,968, filed on May 29, 2001.

(51) Int. Cl. B26B 13/22

(52) U.S. Cl. 30/125; 30/131

(57) ABSTRACT

This is a combination of a survival scissors and knife wherein both the knife and the scissors are formed with elements which can be used for making fires under emergency situations. Additonally such elements may be used for defense and for clearing cluttered or entangled areas and for making snow caves.

### BACKGROUND OF THE INVENTION

I. Field of the Invention

This invention is in the general field of protective methods and apparatus;

The invention is even more particularly in the general field of useful methods and apparatus for individuals of all levels of physical abilities to assist in overcoming difficult circumstances such as personal endangering situations, property protection, transport convenience and the like.

The invention is most particularly directed to particular cutting and fire making devices and methods.

II. Description of the Prior Art

There have been many cutting devices and the like for various personal assistance uses such as cutting wood, cutting entangled cords, and the like. Also, there have been fire making devices, waterproof match containers and the like.

However, all such uses contemplate a supply of tape on a roll of some sort. In some cases, people have wound small amounts of Duct Tape from a large roll onto a pencil, or other small object, in order to create a quantity of tape in a more convenient carrying package.

Additionally, alternate methods of cutting tape, particularly tape which has already been removed from its storage unit are deemed desirable. In this connection, a convenient general purpose cutting instrument is desirable.

I have now improved upon my device described in my co-pending application for patent referred to above in order to include improved new, unique, and useful methods and implements for outdoors persons and the like. My inventions now include means and methods for cutting and shaving incendiary materials which are actually parts of the cutting means, for starting fires, for visual examination of various things, and for general aid and assistance under adverse conditions. I have searched in the literature, patent files, commercial sources, and the like. I have found no readily useable, durable, and inexpensive device or method for carrying and cutting and shaving incendiary materials, for starting fires, for visual examination of various things, and for general aid and assistance under adverse conditions. I have found no prior art as to the items described in my afore referenced patent application. I have, however, found prior art which, at first glance, appears to be related to what I have conceived and developed relating to means and methods for cutting and shaving incendiary materials, for starting fires, for visual examination of various things, and for general aid and assistance under adverse conditions.

The prior art I have found which may appear to have some of the features of my invention include the following U.S. Pat. No. 4,698,068; 4,882,841; 4,944,392; and 5,214,853. Examining those patents I have found that they cannot accomplish, and do not suggest nor anticipate the multitude of things which my invention accomplishes.

Thus, I have found nothing which I consider to be complete prior art as to my present invention as is described below.

### SUMMARY OF THE INVENTION

There are numerous situations in which individuals, regardless of their physical prowess, find themselves unable to cope with immediate and temporary emergencies. Such situations occur in avalanches, boating mishaps, storms, and the like.

Under emergency circumstances of the nature mentioned, and others, people frequently need to have superior cutting instruments, visual magnifying aides, and fire making ability.

In many of such circumstances there may be unusual conditions which make it difficult or impossible to start a fire with customary matches, lighters, or the like. As examples, a person attempting to use the survival tape disclosed in my above referenced co-pending application for one of the purposes for which it is designed may fall into a lake, river, swamp or the like. Under this circumstance matches, lighters, and the like may be unusable, yet it may be vital that a fire be started. There are, also, cases where a magnified view of something is essential, such as a small sliver in a foot.

This invention is directed to devices for cutting and for defense against animals and the like as well as means to cut and use tape, cord, and the like as well as provide universally adaptable means for visual magnification and for fire starting incorporated into, and a part of, the cutting devices.

An object of this invention is to provide superior cutting tools for use in outdoors activities;

Another object of this invention is to provide a scissors which can be disassembled and utilized as knives;

Another object of this invention is to provide scissors which can be utilized as a fire starting device;

Another object of this invention is to provide a knife which can be used as a personal survival instrument;

Another object of this invention is to provide a knife which can be used as a fire starting device.

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a schematic perspective of a scissors suitable to practice some of the methods of this invention;

FIG. 2 is an exploded view of the apparatus of FIG. 1;

FIG. 3A is a schematic perspective of one use of the scissors of FIGS. 1 and 2 to start a fire;

FIG. 3B is a schematic perspective of another use of the scissors of FIGS. 1 and 2 to start a fire;

FIG. 3C is a schematic perspective of the use of the scissors of FIGS. 1 and 2 to prepare an easily ignitable tinder for use in the manner of FIGS. 3A and 3B;

FIG. 4 is a schematic exploded view of a pocket knife which can be used for many of the functions of the scissors of this invention;

FIG. 5A is a schematic perspective of one use of the knife of FIG. 4 to start a fire;

FIG. 5B is a schematic perspective of another use of the knife of FIG. 4 to start a fire; and

FIG. 5C is a schematic perspective of the use of the knife of FIG. 4 to prepare an easily ignitable tinder for use in the manner of FIGS. 5A and 5B;

### DESCRIPTION OF A PREFERRED EMBODIMENT

An inventory of the items bearing reference numerals on the drawings is:

| Numeral | Identification of item |
|---|---|
| 200 | scissors |
| 210 | one scissor blade and handle |
| 210a | handle |
| 210b | blade |
| 212 | finger opening |
| 213 | spark |
| 214 | tinder storage compartment |
| 215 | tinder storage compartment cover |
| 216 | cover pin |
| 216a | pin hole |
| 217 | scissor blade connector |
| 218 | flint |
| 218a | flint holder |
| 219 | striker |
| 220 | one scissor blade and handle |
| 220a | handle |
| 220b | blade |
| 222 | finger hole |
| 223 | compartment in handle for magnifying glass |
| 224 | magnifying glass |
| 227 | scissor blade connector |
| 228 | magnesium |
| 228a | magnesium shavings |
| 230 | tinder |
| 231 | concentrated sunlight |
| 300 | knife |
| 301 | blade |
| 310 | handle center |
| 312 | handle mounting stud |
| 315 | magnifying glass |
| 316 | magnesium |
| 316a | magnesium shavings |
| 318 | shoulder |
| 319 | shoulder |
| 320 | handle carrying tinder and flint |
| 322 | socket for handle stud |
| 328 | flint |
| 330 | tinder |
| 331 | sunlight concentrated by magnifying glass |
| 340 | handle carrying magnesium and magnifying glass |
| 342 | socket for handle stud |
| 343 | opening in handle for carrying magnifying glass (not visible) |

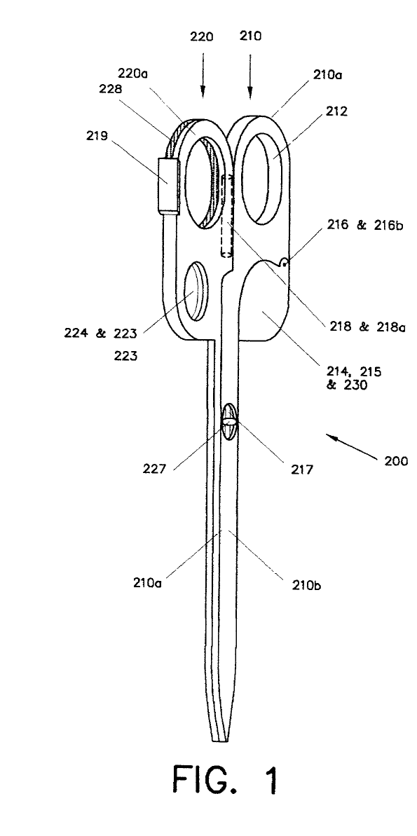

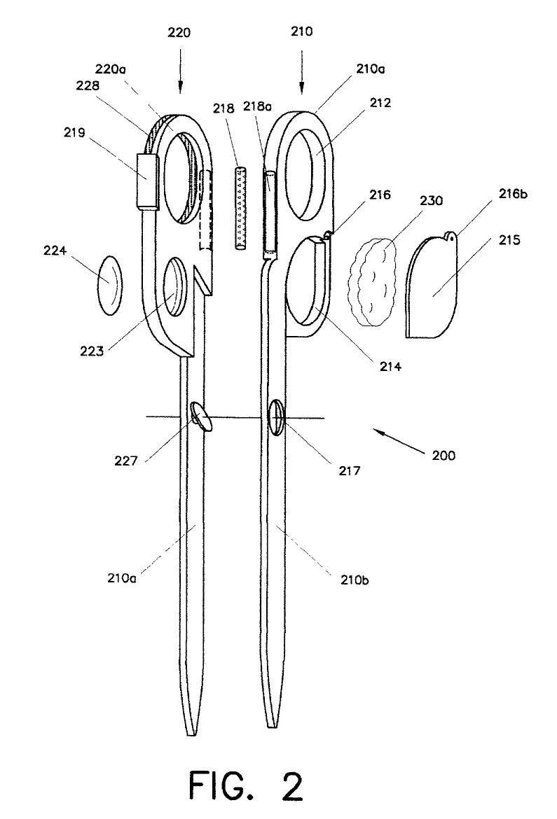

FIGS. 1, 2, 3A, 3B, and 3C show a unique, novel, and useful scissors some of its uses. The scissors consists of two blade and handle elements 210 and 220. The two elements are connectable by the interconnection of connectors 217 and 227. There can be a large number of different ways to accomplish this as will be understood by those skilled in the art. The handle and blade elements 210a/210b and 220a/220b are purposely made detachable for specific uses as herein described. Handle 210a has a finger opening 212 and a compartment 214 which is used for storage of tinder 230. The tinder may be any relatively easily ignited material such as cotton or the like. A cover 215 is pivotally connected to the handle by pin 216 through pin hole 216a as will be known to those skilled in the art. If desired, there may be a gasket on the cover to ensure that the tinder 230 will stay dry when in the compartment.

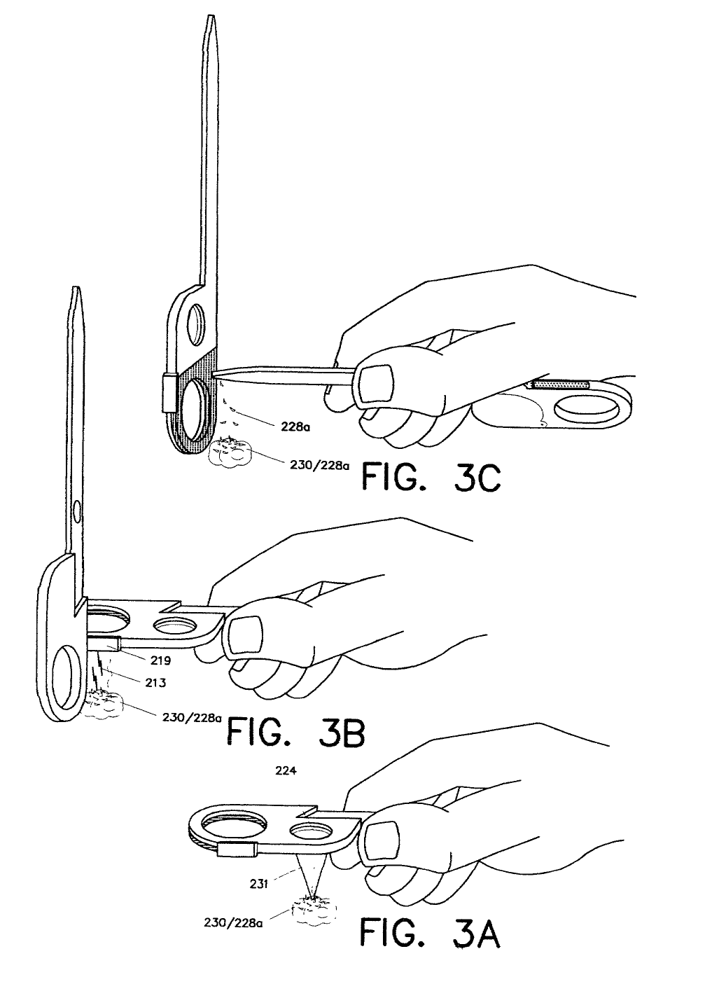

A flint 218 is adhered to the handle 210a by adhesive or other means known to those skilled in the art. The flint 218 may actually be flint stone, or any substitute which will yield sparks 213 when appropriately struck by an appropriate striker 219 shown in FIG. 3B and as is known to those skilled in the art. Handle 220a will carry a ring of magnesium 228 or other material such as balsa wood or the like which can be shredded into a highly combustible bits of material 228a by blade 210b as shown in FIG. 3C. The highly combustible material 228a is collected on the tinder 230 making it an excellent fire starting combination. Alternatively the tinder and shredded combustible material 230/228a may be ignited by concentrating the rays of sunlight through magnifying glass 224 in handle 220a and as shown in FIG. 3A.

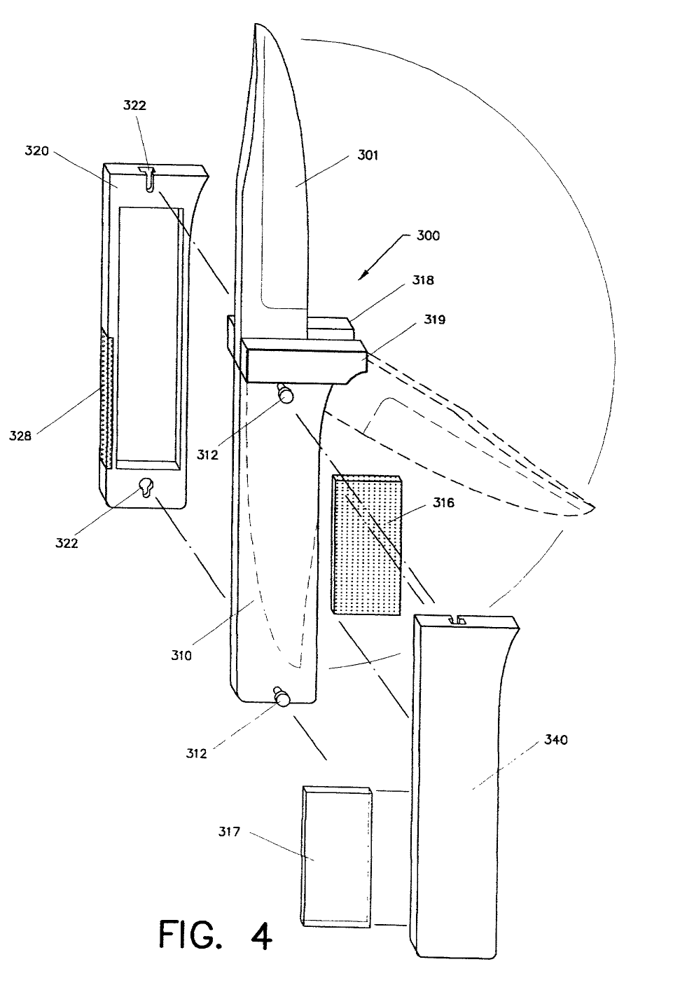

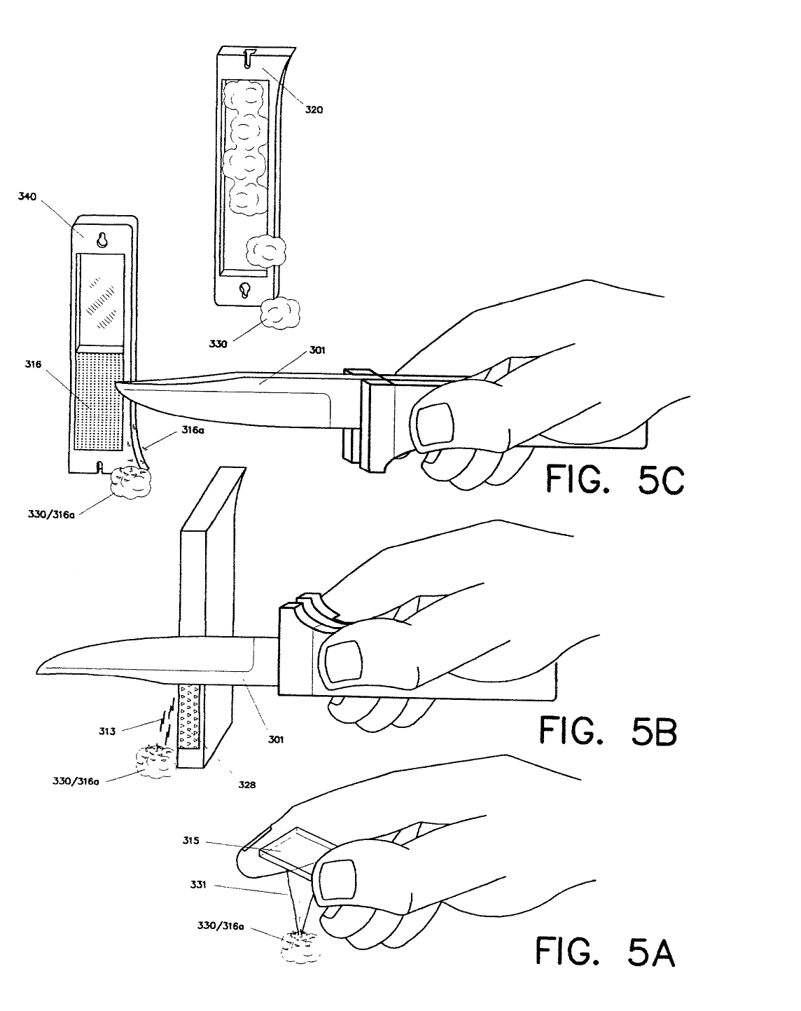

FIGS. 4, 5A, 5B, and 5C illustrate a knife which I have now developed which may be carried in the polyhedron tape core previously described, or independent thereof. The knife 300 is shown exploded in FIG. 8 and being used to start fires in FIGS. 5A, 5B, and 5C. The knife handle is formed in three segments. The center portion 310 of the handle has a slot to receive the blade 301 when not in use. The slot is not shown, nor is the knife blade hinge, but these are well known to those skilled in the art. Exterior handle portions 320 and 340 are essentially mirror images of one another. Handle 320 has a compartment carrying tinder 330. Handle 340 has a compartment carrying magnesium 316 and magnifying glass 317. Handle portions 320 and 340 mount under shoulders 318 and 319. Handle portion 320 snaps into place on handle portion 310 by engaging its two sockets 322 on two studs, not visible on FIG. 4, but identical mirror images of studs 312 which will be understood by those skilled in the art. Handle portion 340 snaps into position in a similar manner utilizing two studs 312 and two sockets 342, only one of which is visible on FIG. 4. In use for making a fire the magnifying glass 315 is removed from its compartment and used to concentrate sunlight 331 to ignite tinder/shavings consisting of cotton or the like 330 and shavings of magnesium or the like 316a. Alternatively, fire may be started by shaving magnesium or the like 316a with knife blade 301 from the block of magnesium or the like 316 onto cotton tinder or the like 330 as shown in FIG. 9c and then creating sparks 313 onto the tinder/magnesium 330/316a by striking flint 328 with knife blade 301 as shown in FIG. 9B.

In the claims which follow, if I should fail to claim a patentable feature of this invention, such failure to claim will be due to inadvertence and not due to any intent to abandon, or dedicate such feature. In the event I learn of any such patentable feature which I have not claimed, I shall immediately seek to claim such feature by re-issue or other appropriate action.

While the embodiments of this invention shown and described are fully capable of achieving the objects and advantages desired, it is to be understood that such embodiments have been shown for purposes of illustration and not for purposes of limitation.

I claim:

1. A survival scissors comprising: a first scissor blade and handle member wherein the handle carries a magnifying glass, a combustible material capable of being shaved by a scissor blade, and a striker; a second blade and handle member wherein the handle carries a compartment for storage of tinder and a flint; and detachable means connecting said first and second blade and handle members.

2. A survival knife comprising: a first handle member; a second handle member incorporating a tinder storage compartment and a flint detachably connected to said first handle member; and a third handle member containing a magnifying glass and a combustible material cable of being shaved by said knife blade detachably connected to said first handle member.
